(19) United States
(12) Patent Application Publication
(10) Pub. No.: US 2008/0187211 A1
(43) Pub. Date: Aug. 7, 2008

(54) Global matching methods used to fabricate semiconductor devices

(75) Inventors: Chan-Kyeong Hyon, Gyeonggi-do (KR); Young-Seog Kang, Gyeonggi-do (KR); Sang-Ho Lee, Gyeonggi-do (KR)

Correspondence Address: MYERS BIGEL SIBLEY & SAJOVEC, PO BOX 37428, RALEIGH, NC, 27627, US

(73) Assignee: Samsung Electronics Co., Ltd.

(21) Appl. No.: 11/880,495

(22) Filed: Jul. 23, 2007

(30) Foreign Application Priority Data
Oct. 26, 2006 (KR) 2006-0104322

(51) Int. Cl. G06K 9/00

(52) U.S. Cl. 382/145

(57) ABSTRACT

A global matching method for semiconductor memory device fabrication may include extracting a graphic data system (GDS) image and a scanning electron microscope (SEM) image of patterns in a region on a wafer. First directional edges extending in a first direction and second directional edges extending in a second direction may be separately extracted from each of the GDS image and the SEM image with the first and second directions being different. The GDS image and the SEM image may be matched with respect to either the first directional edges or the second directional edges which are relatively shorter. After the relatively shorter edges of the GDS image and the SEM image are matched, the GDS image and the SEM image may be matched with respect to relatively longer edges, based on a result of the matching with respect to the relatively shorter edges, thereby completing pattern matching of the GDS image and the SEM image.

### RELATED APPLICATION

This application claims the benefit of Korean Patent Application No. 10-2006-0104322, filed Oct. 26, 2006, the disclosure of which is hereby incorporated herein by reference in its entirety.

### FIELD OF THE INVENTION

The present invention relates to semiconductor devices, and more particularly, to fabrication of semiconductor devices.

### BACKGROUND

A semiconductor memory device may be fabricated by depositing thin films providing different functions on a wafer surface, and patterning the thin films to provide various circuit structures. Processes for semiconductor memory device fabrication may include: impurity ion implantation processes used to implant impurity ions of Group 3B (for example, B) or 5B (for example, P or As) into a semiconductor material; thin film deposition processes used to form layers on a substrate; etching processes used to selectively remove portions of the layers in predetermined patterns; chemical mechanical polishing (CMP) processes used to remove height irregularity and/or to planarize a top surface of a wafer by polishing the wafer surface after depositing an interlayer insulating layer or other layers on the wafer; and/or wafer and/or chamber cleaning processes used to remove impurities.

As technologies in the fields of information processing and communications have rapidly developed and information media (such as information media for computers) have become more popular, semiconductor memory devices have also developed swiftly. Accordingly, semiconductor memory devices may need to operate at relatively high speed and to provide relatively high storage capacity. Semiconductor memory devices are thus being developed to provide higher integration densities, and design rules are being reduced as integration densities of semiconductor memory devices are increased. Accordingly, when a semiconductor memory device is fabricated using the aforementioned processes, a quality of step coverage of a material layer may be reduced due to height irregularities between adjacent patterns, and resolution of photolithography processes may be reduced, so that an accurate profile may be difficult to obtain. Moreover, misalignment may be caused by lack of process margin, so that reliability of the semiconductor memory device may be reduced and yield of production may be reduced.

As capacity and integration density of memory devices are increased, each unit element forming a memory cell may be reduced in size and process margins may be reduced. Technologies used to provide relatively high integration densities may provide multi-layer structures within a reduced area at a reduced process margin. To provide higher integration densities for multi-layer structures, for example, a double layer process and/or a transistor stacking process may be used. A double layer process connects a number of metal layers to one another using metal via contacts. A transistor stacking process forms two or more transistors in a vertical structure on a same vertical line of a semiconductor substrate. Because an SRAM may provide relatively low power consumption and/or relatively high operating speed, compared to other memories, SRAMs are widely used as cache memory for high capacity and high performance computers. An SRAM may have a relatively low integration density, however, compared to other memories, because one cell structure includes six transistors. Therefore, the aforementioned double layer processes and stacked transistor structures (which are realized by stacking transistors in at least two or more layers) may be used.

While double layer processes and/or stacked transistor structures may be used to provide higher integration for semiconductor memory devices, relatively high accuracy may be required for processes used to provide higher integration.

For example, an etching process may be used to remove unnecessary portions of a thin film while maintaining desired portions of the thin film deposited on a semiconductor substrate. Etching processes may be classified as wet etching processes or as dry etching processes. A wet etching process is used to pattern a thin film using a liquid chemical etchant. A dry etching process is used to pattern a thin film using a gas plasma, an ion beam, and/or sputtering, without using a liquid chemical etchant. However, as semiconductor devices become more highly integrated, a height irregularity between unit regions forming memory cells may increase so that an aspect ratio increases and critical dimensions of a circuit pattern are reduced to provide higher integration. Because dry etching may be capable of forming a more precise pattern, use of dry etching is increasing.

A photolithographic etching process used to transfer a pattern from a reticle (mask) to the wafer surface may include: applying photoresist on the entire top surface of a wafer; baking by applying heat to maintain uniformity of the photoresist applied onto the entire top surface of the wafer; partially exposing the photoresist corresponding to the pattern formed on the recticle (mask) by emitting radiation (such as ultraviolet light) through the reticle; developing to remove portions of the photoresist exposed to the radiation or to remove portions of the photoresist not exposed to the radiation by spraying a developing solution onto the wafer after the exposure; and measuring an aligned state of the developed pattern and a pattern under the developed pattern to determine if significant defects exist.

In a testing operation, an overlay measurement device may be used to check if a pattern formed by a previous photolithography process and the photoresist pattern formed by the current photolithography process are properly aligned. As semiconductor memory devices are provided with higher integration and smaller size, an overlay extent between a previously patterned lower layer and an upper layer may be an important factor in yield and reliability of a semiconductor memory device. An overlay between lower and upper layers may be measured using an overlay mark including an amin scale and a vernier scale. The overlay mark may be formed on a scribe region so as not to influence a memory cell region.

During testing to check the overlay, a width of the pattern transferred onto the wafer may be checked using a critical dimension scanning electronic beam microscope (CDSEM). However, as integration densities are increased in semiconductor chip fabrication processes, a number of critical dimension (CD) measurement points to be tested in each process may also increase. In this regard, an AUTO CDSEM systems may be used.

Further, a metrology automation system may be used to measure a relatively large number of measurement points. A metrology automation system may perform global matching by connecting an image of a graphic data system (GDS) (which is a layout storing format) to a CDSEM image and matching the GDS image and the CDSEM image at a measurement position. Because an algorithm used to match the GDS image and the image obtained from the CDSEM may be incomplete, however, a matching rate between the patterns may be about 95%. Thus, a point where a matching failure occurs may be treated by modifying the recipe.

FIG. 1 is a GDS image 14 within a field of view (FOV). FIG. 1 illustrates the GDS image 14 relative to a pattern 12 formed on a lower material layer 10. An origin 16 of the GDS image 14 is indicated in a center region of the GDS image 14. FIG. 2 illustrates a matched state between the GDS image 14 within the FOV shown in FIG. 1 and a CDSEM image relative to a pattern 12′ formed on a material layer 10′ on an actual semiconductor substrate.

Referring to FIG. 2, the CDSEM image does not correspond exactly to the GDS image 14 of FIG. 1. More specifically, upon comparing the GDS image 14 of FIG. 1 and the CDSEM image of FIG. 2, Y-directional edges of the patterns 12 and 12′ substantially correspond to each other. However, X-directional edges of the patterns 12 and 12′ of the GDS image 14 and the CDSEM image do not correspond to each other in a part indicated as reference mark “A”. As a result of actual measurement, a position of the X-directional edge of the pattern 12 of the GDS image 14 is inclined downwardly by about 300 nm, compared to a position of the X-directional edge of the actual pattern 12′ measured by the CDSEM. Reasons why the GDS image 14 within the FOV does not correspond to the CDSEM image of the actual pattern as illustrated in FIG. 2 are discussed below.

Measurement points are selected as the FOV and measured by the CDSEM, thereby providing an image of a pattern in a region of the FOV and performing a global matching between the CDSEM image and the GDS image. During the global matching process, when a numerical value difference between the length of the X-directional edge and the length of the Y-directional edge in the GDS image 14 is relatively great, a directional edge being relatively shorter may be disregarded. That is, as illustrated in FIGS. 1 and 2, the X-directional edges in the GDS image and the CDSEM image may be relatively shorter than the Y-directional edges thereof. As for the X-directional edge of the GDS image 14 and the X-directional edge of the CDSEM image which are relatively shorter, the matching process may be omitted, so that pattern matching may not be properly performed. Consequently, a probability that the pattern matching between the GDS image 14 and the CDSEM image is accurately performed may be relatively low.

When the global matching between the GDS image and the CDSEM image is not properly performed, a measurement failure may occur, causing a CD value of an undesired position to be measured. This measurement failure may reduce reliability of the obtained measurement value and may cause a failure in monitoring a process using the measurement value.

Moreover, when global matching between the GDS image and the CDSEM image is not properly performed, a relatively large number of measurement points may need to be reviewed and points that fail matching may need to be re-measured, thereby reducing a rate of operation of the metrology system.

When inaccurate global matching between a GDS design within the FOV and the CDSEM image of the actual pattern is performed, alignment of the patterns which will be formed during subsequent processes may become progressively worse. Reliability and/or productivity of semiconductor memory device fabrication may be reduced.

### SUMMARY

According to some embodiments of the present invention, a global matching method for semiconductor memory device fabrication may include extracting a graphic data system (GDS) image and a scanning electron microscope (SEM) image of a pattern in a region on a wafer; separately extracting first directional edges, which extend in a first direction, and second directional edges, which extend in a second direction different from the first direction and are longer than the first directional edges, from each of the GDS image and the SEM image; matching the first directional edges of the GDS image and the first directional edges of the SEM image; and based on a result of the matching of the first directional edges, matching the second directional edges of the GDS image and the second directional edges of the SEM image, thereby completing pattern matching between the GDS image and the SEM image.

Separately extracting the first and second directional edges from the SEM image may include defining edges of the pattern in the SEM image; squaring rounded portions of the edges to provide a straightened SEM image; and separately extracting the first and second directional edges from the straightened SEM image.

According to some other embodiments of the present invention, a global matching method for semiconductor memory device fabrication may include extracting a graphic data system (GDS) image and a scanning electron microscope (SEM) image of a pattern in a region on a wafer; separately extracting first directional edges, which extend in a first direction, and second directional edges, which extend in a second direction different from the first direction, from each of the GDS image and the SEM image; matching the first directional edges of the GDS image and the first directional edges of the SEM image; and based on a result of the matching of the first directional edges, matching the second directional edges of the GDS image and the second directional edges of the SEM image, thereby completing pattern matching between the GDS image and the SEM image.

Separately extracting the first and second directional edges from the SEM image may include defining edges of the pattern in the SEM image; squaring rounded portions of the edges to provide a straightened SEM image; and separately extracting the first and second directional edges from the straightened SEM image.

According to still other embodiments of the present invention, a global matching method for semiconductor memory device fabrication may include extracting a graphic data system (GDS) image of a pattern in a region on a wafer; separately extracting first directional edges, which extend in a first direction, and second directional edges, which extend in a second direction different from the first direction, from the GDS image; measuring a scanning electron microscope (SEM) image of the pattern; separately extracting first directional edges, which extend in the first direction, and second directional edges, which extend in the second direction and are longer than the first directional edges, from the SEM image; matching the first directional edges of the GDS image and the first directional edges of the SEM image; and based on a result of the matching of the first directional edges, matching the second directional edges of the GDS image and the second directional edges of the SEM image, thereby completing pattern matching between the GDS image and the SEM image.

In addition, separately extracting the first and second directional edges from the SEM image may include: defining edges of the pattern in the SEM image; squaring rounded portions of the edges to provide a straightened SEM image; and separately extracting the first and second directional edges from the straightened SEM image.

According to yet other embodiments of the present invention, a global matching method for semiconductor memory device fabrication may include extracting a GDS image of a pattern in a region on a wafer; separately extracting first directional edges, which extend in a first direction, and second directional edges, which extend in a second direction different from the first direction, from the GDS image; measuring a scanning electron microscope (SEM) image of the pattern; separately extracting first directional edges, which extend in the first direction, and second directional edges, which extend in the second direction, from the SEM image; matching the first directional edges of the GDS image and the first directional edges of the SEM image; and based on a result of the matching of the first directional edges, matching the second directional edges of the GDS image and the second directional edges of the SEM image, thereby completing pattern matching between the GDS image and the SEM image.

Separately extracting the first and second directional edges from the SEM image may include defining edges of the pattern in the SEM image; squaring rounded portions of the edges to provide a straightened SEM image; and separately extracting the first and second directional edges from the straightened SEM image.

According to embodiments of the present invention, a global matching method for semiconductor memory device fabrication may increase a success rate of global matching between a graphic data system (GDS) image and a critical dimension scanning electronic beam microscope (CDSEM) image.

According to other embodiments of the present invention, a global matching method for semiconductor memory device fabrication may improve a rate of operation of a metrology system by reducing a time required for global matching between the GDS image and the CDSEM image.

According to some other embodiments of the present invention, a global matching method for semiconductor memory device fabrication may improve reliability and/or productivity of a semiconductor memory device.

According to some embodiments of the present invention, a global matching method for semiconductor memory device fabrication may include extracting a graphic data system (GDS) image of patterns in a predetermined region on a wafer; and separately extracting first directional edges, which extend in a first direction, and second directional edges, which extend in a second direction different from the first direction, from the GDS image; acquiring a scanning electron microscope (SEM) image of the patterns; separately extracting first directional edges, extending in the first direction, and second directional edges, extending in the second direction, from the SEM image; primarily matching either the first directional edges or the second directional edges of the GDS image to corresponding edges of the SEM image; and secondarily matching the other edges of the GDS image to corresponding edges of the SEM image, based on a result of the primary matching, thereby completing pattern matching between the GDS image and the SEM image.

According to other embodiments of the present invention, a global matching method for semiconductor memory device fabrication may include extracting a GDS image of a pattern in a predetermined region on a wafer; separately extracting first directional edges, which extend in a first direction, and second directional edges, which extend in a second direction different from the first direction and are relatively longer than the first directional edges, from the GDS image; acquiring an SEM image of the patterns; separately extracting first directional edges, extending in the first direction, and second directional edges, extending in the second direction, from the SEM image; primarily matching the first directional edges of the GDS image to the first directional edges of the SEM image; and secondarily matching the second directional edges of the GDS image to the second directional edges of the SEM image, based on a result of the primary matching, thereby completing pattern matching of the GDS image and the SEM image.

### BRIEF DESCRIPTION OF THE DRAWINGS

FIG. 1 is a plan view illustrating a graphic data system (GDS) image within a field of view (FOV).

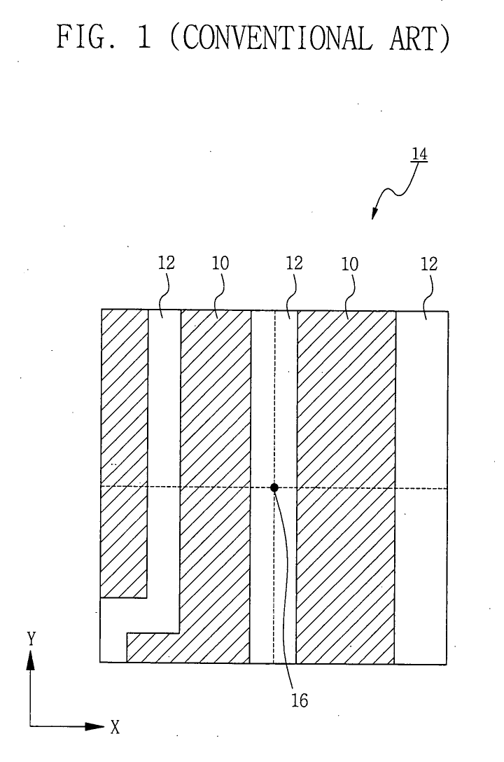

FIG. 2 is a view illustrating a matched state between the GDS image within the FOV of FIG. 1 and a critical dimension scanning electronic beam microscope (CDSEM) image within the FOV.

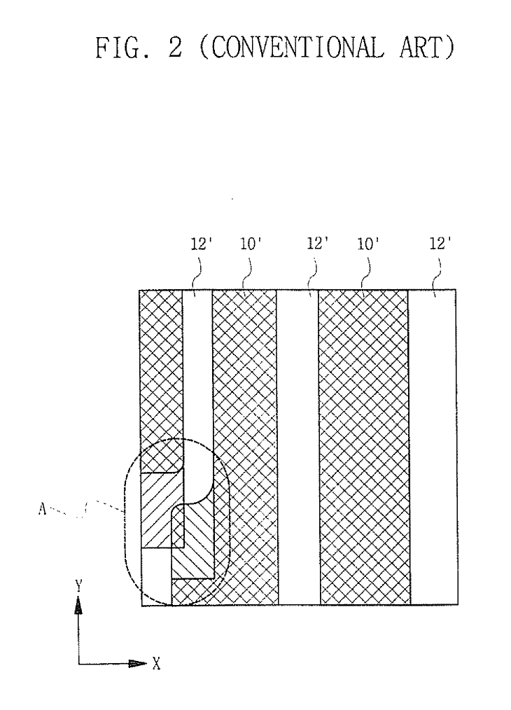

FIG. 3 is a flow chart illustrating a global matching process according to embodiments of the present invention.

FIG. 4 is a plan view illustrating a GDS image relative to patterns to be formed on a lower material layer according to embodiments of the present invention.

FIG. 5 is a plan view illustrating X-directional edges which are separately extracted from the GDS image of FIG. 4.

FIG. 6 is a plan view illustrating Y-directional edges which are separately extracted from the GDS image of FIG. 4.

FIG. 7 is a view illustrating a scanning electron microscope (SEM) image corresponding to the GDS image of FIG. 4.

FIG. 8 is a plan view illustrating edges of patterns which are extracted from the SEM image of FIG. 7.

FIG. 9 is a view illustrating a straightened SEM image obtained by squaring rounded portions of the edges of FIG. 8.

FIG. 10 is a plan view illustrating X-directional edges which are separately extracted from the straightened SEM image of FIG. 9.

FIG. 11 is a plan view illustrating Y-directional edges which are separately extracted from the straightened SEM image of FIG. 9.

FIG. 12 is an SEM image illustrating a result of matching between the X-directional edges of the GDS image of FIG. 5 and the X-directional edges of the SEM image of FIG. 10.

FIG. 13 is an SEM image illustrating a result of matching between the Y-directional edges of the GDS image of FIG. 6 and the Y-directional edges of the SEM image of FIG. 11.

FIG. 14 is an SEM image illustrating a result of global matching between the GDS image of FIG. 4 and the SEM image of FIG. 7.

### DETAILED DESCRIPTION

The present invention is described more fully hereinafter with reference to the accompanying drawings, in which embodiments of the present invention are shown. This invention may, however, be embodied in many different forms and should not be construed as limited to the embodiments set forth herein. Rather, these embodiments are provided so that this disclosure will be thorough and complete, and will fully convey the scope of the present invention to those skilled in the art. In the drawings, the sizes and relative sizes of layers and regions may be exaggerated for clarity. Like numbers refer to like elements throughout.

It will be understood that when an element is referred to as being “adjacent”, “on”, “connected to” or “coupled to” another element, it can be directly adjacent, on, connected or coupled to the other element, or intervening elements may be present. In contrast, when an element is referred to as being “directly adjacent”, “directly on,” “directly connected to” or “directly coupled to” another element, there are no intervening elements present. As used herein, the term “and/or” includes any and all combinations of one or more of the associated listed items.

It will be understood that, although the terms first, second, third etc. may be used herein to describe various elements, components, regions, layers, and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in Use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly. Also, as used herein, “lateral” refers to a direction that is substantially orthogonal to a vertical direction.

The terminology used herein is for the purpose of describing particular embodiments only, and is not intended to be limiting of the present invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. Accordingly, these terms can include equivalent terms that are created after such time. It will be further understood that terms, such as those defined in commonly used dictionaries, should be interpreted as having a meaning that is consistent with their meaning in the present specification and in the context of the relevant art, and will not be interpreted in an idealized or overly formal sense unless expressly so defined herein. All publications, patent applications, patents, and other references mentioned herein are incorporated by reference in their entirety.

As integration density is increased for semiconductor chip fabrication processes, a number of critical dimension (CD) measurement points to be tested at each process may also increase. In this field, an AUTO critical dimension scanning electronic beam microscope (CDSEM) system may be used to perform smooth CD measurement at a number of measurement points. Further, a metrology automation system may be used to effectively measure a relatively large number of measurement points (according to a recipe), by performing global matching where a graphic data system (GDS) (which is a layout storing format) is connected to the AUTO CDSEM and a GDS image and a CDSEM image are matched at a measurement position(s).

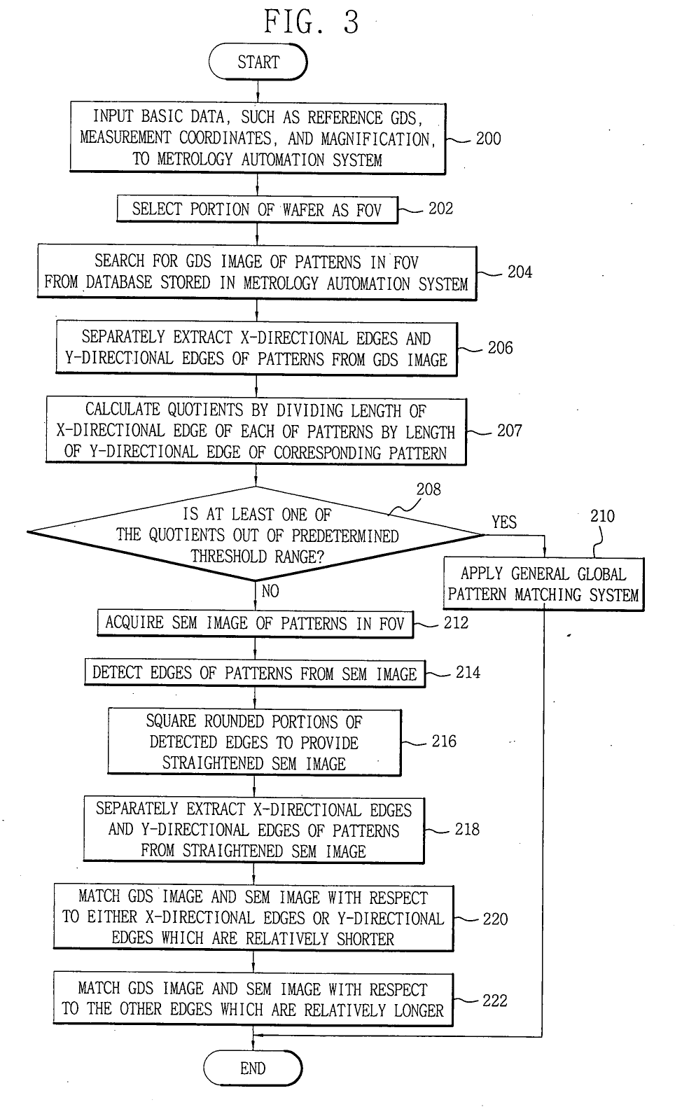

In a conventional system, a matching algorithm between the GDS image and the SEM image obtained from the CDSEM may be incomplete. As a result, a matching rate between the patterns may be about 95% and a point where a matching failure occurs may be re-measured by modifying the recipe. To determine why a matching failure occurs, the image of the pattern in the region where the pattern matching failure occurs may be analyzed. When a dimension of a pattern in a specific direction is a threshold value or less, a matching failure may occur. According to embodiments of the present invention, the dimension of the pattern in the specific direction may be analyzed for pattern recognition and global matching, and a new pattern recognizing method may be applied to an image of a pattern which has a dimension in a specific direction equal to or less than the threshold value. A pattern recognition rate and a global matching rate may thus be improved. A global matching process in accordance with embodiments of the present invention will be described, in detail, with reference to FIGS. 3 through 11.

FIG. 3 is a flow chart illustrating a global matching process according to some embodiments of the present invention. Referring to FIG. 3, at block 200, basic data (such as a reference GDS, measurement coordinates, magnification, etc.) is input to a metrology automation system. At block 202, a portion of a wafer is selected as a field of view (FOV).

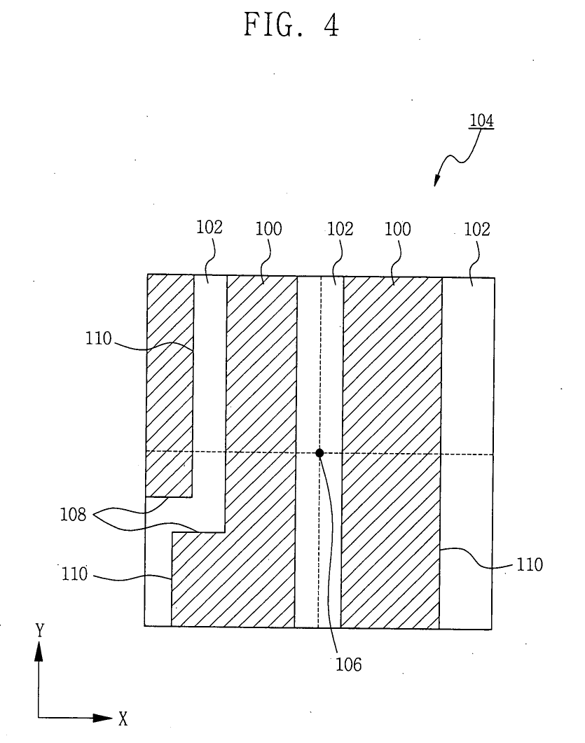

At block 204, a GDS image of patterns in the FOV is searched from a database stored in the metrology automation system. FIG. 4 illustrates a GDS image 104 of patterns 102 to be formed on a lower material layer 100. The origin 106 of the GDS image 104 is indicated in a center region of the GDS image 104.

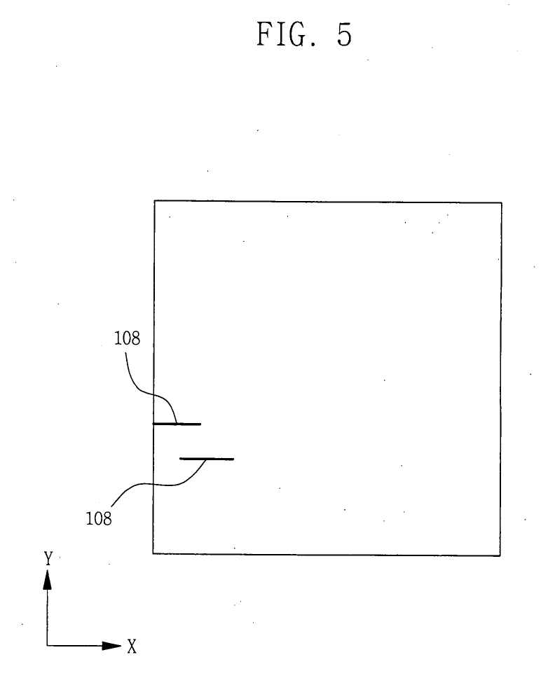

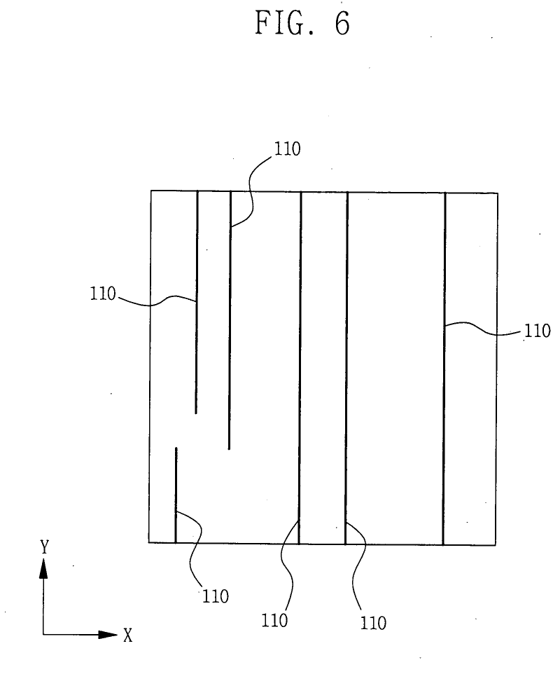

At block 206, edges extending in an X-direction (hereinafter, referred to as X-directional edges) and edges extending in a Y-direction (hereinafter, referred to as Y-directional edges) are separately extracted from the GDS image 104. FIG. 5 illustrates X-directional edges 108 which are separately extracted from the GDS image 104 of the FOV of FIG. 4. Referring to FIG. 4, the X-directional edges may exist in only patterns positioned on the left side of FIG. 4. Thus, FIG. 5 illustrates only the X-directional edges 108 which are separately extracted from the patterns positioned on the left side of FIG. 4. FIG. 6 illustrates Y-directional edges 110 which are separately extracted from the GDS image 104 of the FOV of FIG. 4. Referring to FIG. 4, Y-directional edges may exist in all patterns in the FOV. Thus, in FIG. 6, the Y-directional edges 110 which are separately extracted from all the patterns are illustrated. At block 207, the length of the X-directional edge of each of the patterns is divided by the length of the Y-directional edge of the corresponding pattern, thereby obtaining quotients (hereinafter, referred to as X-to-Y ratios). When a pattern has a plurality of X-directional edges and a plurality of Y-directional edges, the length of the shortest one of the plurality of X-directional edges may be divided by the length of the longest one of the plurality of Y-directional edges to obtain an X-to-Y ratio. Alternatively, the sum of the lengths of the plurality of X-directional edges may be divided by the sum of the lengths of the plurality of Y-directional edges to obtain an X-to-Y ratio.

At block 208, it is determined whether at least one of the X-to-Y ratios is out of a predetermined threshold range.

As a result of the determination at block 208, if the X-to-Y ratios of all the patterns are within the predetermined threshold range, a general global matching system may be applied at block 210. The term threshold range means a reference numerical value range used to determine whether to apply the general global matching system or to apply a global matching system according to embodiments of the present invention.

For example, when the threshold range is set to a range of 0.5 to 2, the length of an X-directional edge of a pattern is 70 micrometers, and the length of a Y-directional edge of the pattern is 100 micrometers, the X-to-Y ratio of the corresponding pattern is 0.7, which is within the threshold range. Or, when the length of an X-directional edge of a pattern is 100 micrometers, and the length of Y-directional edge of the corresponding pattern is 70 micrometers, the X-to-Y ratio of the corresponding pattern is 1.4, which is within the threshold range. When an X-to-Y ratio of a pattern is within the threshold range, the length of the X-directional edge and the length of the Y-directional edge do not have an extreme difference in numerical values. In this case, therefore, significant matching failures may not occur even though the general global matching system (which performs X-directional edge matching and Y-directional edge matching simultaneously) is applied.

As a result of the determination at block 208, if at least one of the X-to-Y ratios of the patterns is out of the predetermined threshold range, the global matching system according to embodiments of the present invention may be applied at blocks 212 to 222. That is, when the X-to-Y ratio of a pattern is out of the threshold range, the length of the X-directional edge and the length of the Y-directional edge may have a relatively great difference in numerical values.

For example, when the threshold range is set to a range of 0.5 to 2, the length of an X-directional edge of a pattern is 10 micrometers, and the length of a Y-directional edge of the corresponding pattern is 100 micrometers, the X-to-Y ratio of the corresponding pattern is 0.1, which is out of the threshold range. In another example, when the length of an X-directional edge of a pattern is 100 micrometers, and the length of a Y-directional edge of the corresponding pattern is 10 micrometers, the X-to-Y ratio of the corresponding pattern is 10, which is out of the threshold range. When the X-to-Y ratio of a pattern is out of the threshold range, the length of the X-directional edge and the length of the Y-directional edge may have a relatively great difference in numerical values.

If the general global matching system, which performs X-directional edge matching and Y-directional edge matching simultaneously, is applied when the length of the X-directional edge and the length of the Y-directional edge have a relatively great difference in numerical values, either the X-directional edge or the Y-directional edge whose length is relatively small may be neglected, so that a matching failure may occur. In this case, a global matching system according to embodiments of the present invention, which preferentially considers an edge whose length is relatively small, may be applied. In accordance with a global matching system according to embodiments of the present invention, after either the X-directional edge or the Y-directional edge whose length is relatively small is preferentially matched, the other edge whose length is relatively large is subsequently matched, based on the preferential matching. When applying the global matching system according to the present invention which preferentially considers an edge whose length is relatively small, matching failures may be reduced.

A substantial global matching process by a global matching system according to embodiments of the present invention will be described, in greater detail, below.

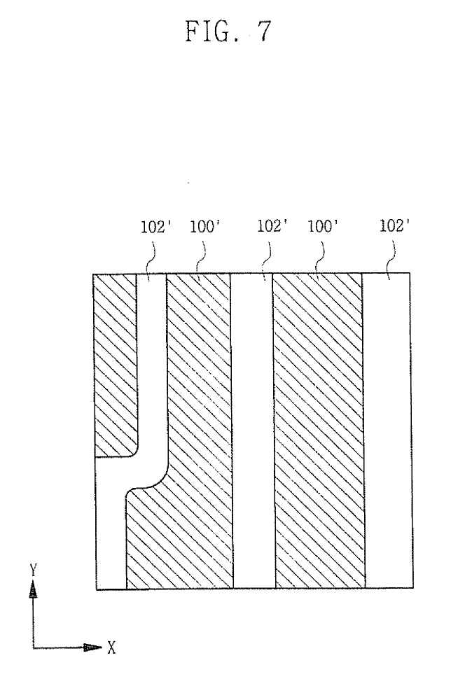

At block 212, a scanning electron microscope (SEM) image of patterns formed on an actual wafer in the FOV determined at block 202 may be acquired using the CDSEM system. FIG. 7 illustrates the SEM image corresponding to the GDS image shown in FIG. 4. Referring to FIG. 7, a plurality of patterns 102′ are spaced apart from one another, on a lower material layer 100′.

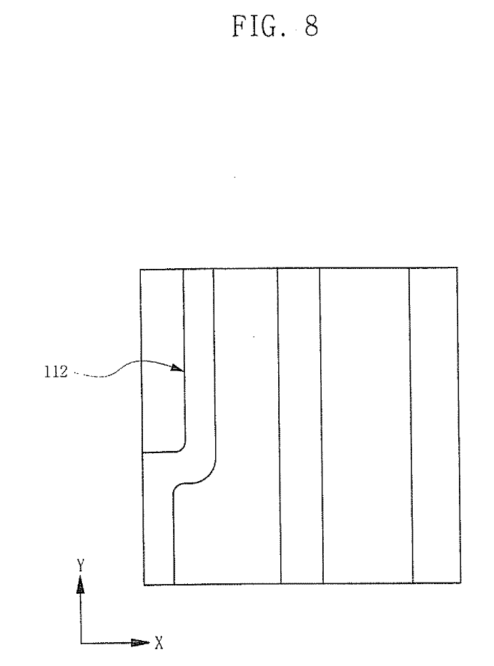

At block 214, edges of the patterns 102 are detected from the SEM image of FIG. 7. The detected edges are illustrated in FIG. 8.

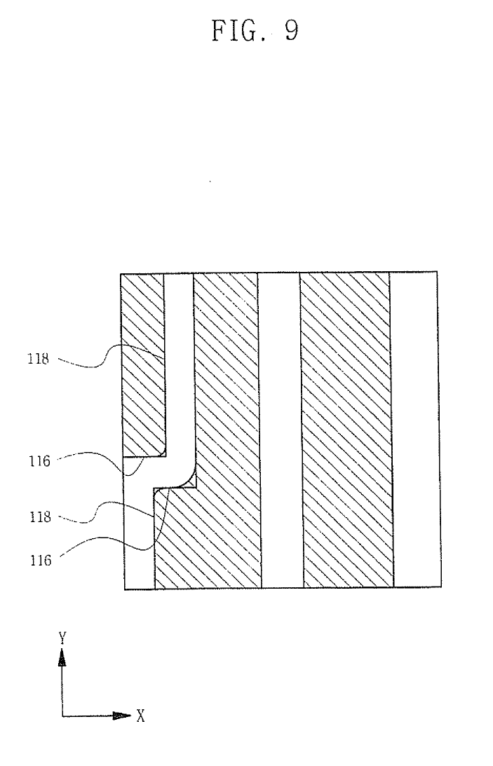

At block 216, the edges are straightened in the X-direction and Y-direction as illustrated in FIG. 9. That is, a straightening process may be performed on the SEM image of FIG. 7 to clearly square rounded portions of the edges of the patterns shown in FIG. 8.

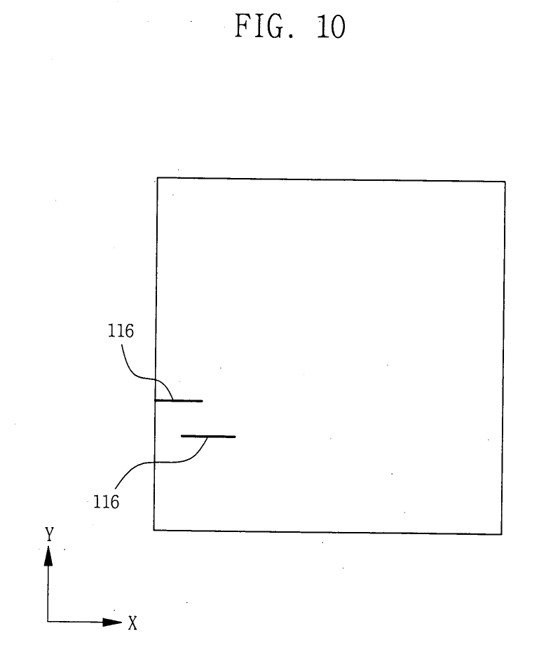

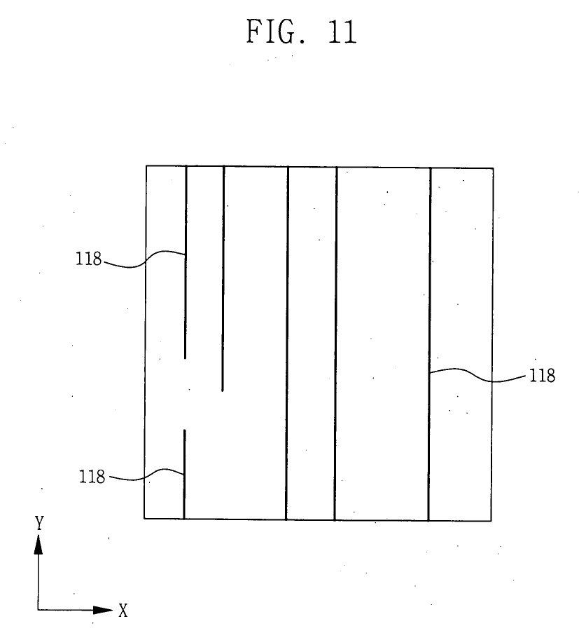

Subsequently, at block 218, X-directional edges and Y-directional edges of the patterns are extracted from the straightened SEM image. The X-directional edges 116 and Y-directional edges 118 are illustrated in FIG. 10 and FIG. 11, respectively.

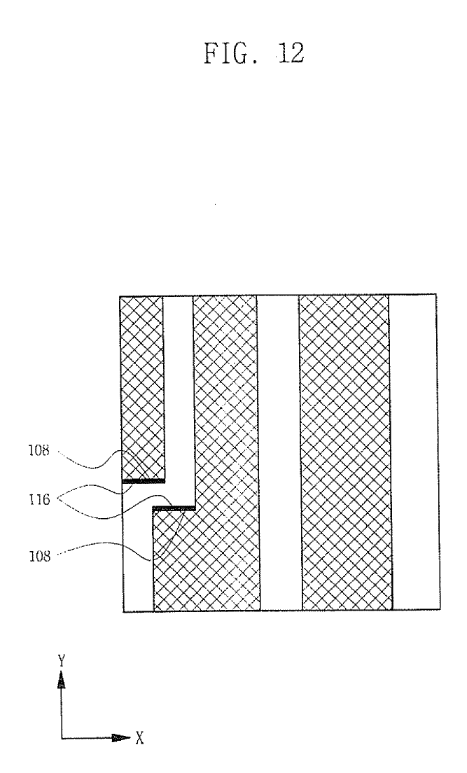

Subsequently, at block 220, the GDS image and the SEM image are primarily matched with respect to edges being relatively shorter, that is, the X-directional edges. FIG. 12 illustrates a result of matching between the X-directional edges 108 of the GDS image and the X-directional edges 116 of the SEM image. Referring to FIG. 12, the X-directional edges 108 of the GDS image of FIG. 5 accurately correspond to the X-directional edges 116 of the SEM image of FIG. 10.

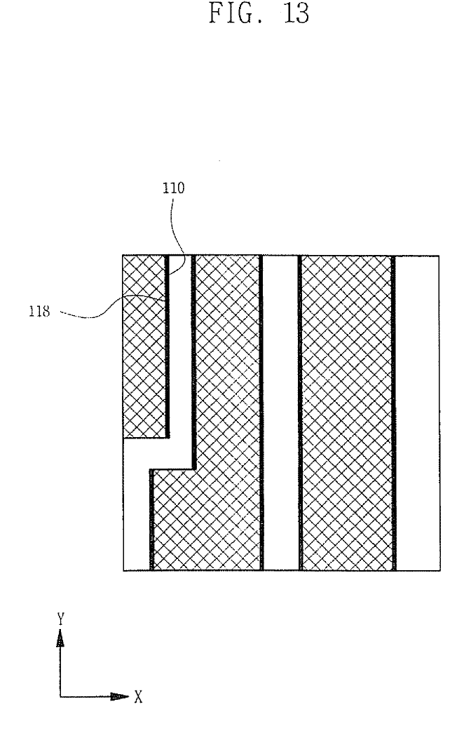

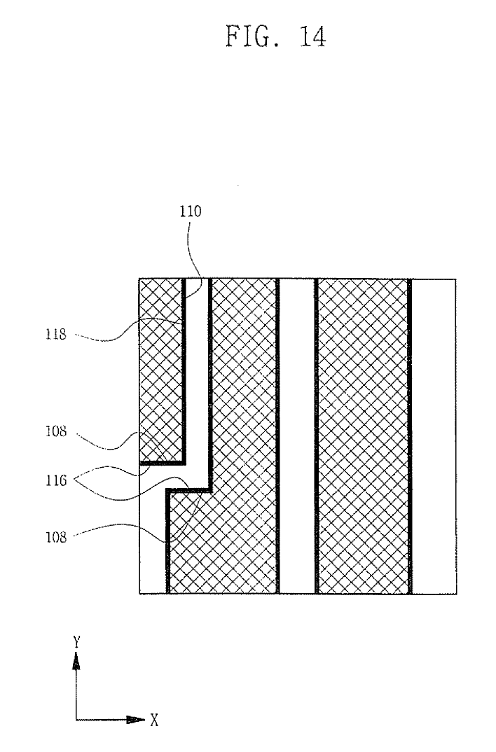

At block 222, the GDS image and the SEM image are secondarily matched, with respect to edges being relatively longer, that is, the Y-directional edges. FIG. 13 illustrates a result of matching between the Y-directional edges 110 of the GDS image and the Y-directional edges 118 of the SEM image. Referring to FIG. 13, the Y-directional edges 110 of the GDS image of FIG. 6 accurately correspond to the Y-directional edges 118 of the SEM image of FIG. 11. In this way, the global matching between the GDS image and the SEM image in the FOV region determined at block 202 may be completed. FIG. 14 illustrates a result of the global matching between the GDS image and the SEM image. Referring to FIG. 14, of the GDS image and the SEM image in the FOV region determined at block 202, the X-directional edges 108 and 116 may accurately correspond to each other, and the Y-directional edges 110 and 118 may accurately correspond to each other.

As described, to perform global matching of a predetermined FOV region according to embodiments of the present invention, the GDS image and the SEM image of the patterns existing in the FOV region may be acquired and X-directional edges and Y-directional edges may be separately extracted from each of the GDS image and the SEM image. Subsequently, the X-directional edges of the GDS image may be matched with the X-directional edges of the SEM image, and the Y-directional edges of the GDS image may be matched with the Y-directional edges of the SEM image, thereby completing the global matching of the predetermined FOV region. According to embodiments of the present invention, final global matching between the GDS image and the SEM image of the predetermined FOV region may be completed by preferentially matching either the X directional edges or Y-directional edges; being relatively shorter, (for example, the X-directional edges in the embodiment of FIGS. 4 to 14), among the X-directional edges and the Y-directional edges of the GDS image and the SEM image, and subsequently matching the other edges, being relatively longer, (for example, the Y-directional edges in the embodiment of FIG. 4 to 14).

In a general global matching method applied at block 210, the global matching may be performed with respect to the X-directional edges and the Y-directional edges extracted from a GDS image and an SEM image of the FOV region, substantially simultaneously. More particularly, either X-directional edges or Y-directional edges, being relatively shorter, among the X-directional and Y-directional edges, may be neglected, making it difficult to perform accurate global matching. Consequently, a rate of operation of a metrology system may be reduced and a quality of alignment for subsequent pattern formation processes may be reduced, if only global matching of block 210 is provided. Reliability and/or productivity of a semiconductor memory device may thus be increased by providing matching of blocks 212 to 224 if there is a significant difference between lengths of edges in the X and Y directions.

As discussed above with respect to blocks 212 to 224, after the X-directional edges and the Y-directional edges are respectively separately extracted from each of the GDS image and the SEM image, matching of either the X-directional edges or the Y directional edges which are relatively shorter (among the X-directional edges and the Y-directional edges) may be initially performed. Then, when matching of the other edges, which are relatively longer, is performed, even the relatively shorter edges may not be neglected and may be entirely and sufficiently reflected in the entire global matching process. Accordingly, a pattern matching rate may be improved so that the pattern matching failure may be reduced. Consequently, global matching between the GDS image and the SEM image of the predetermined FOV region may be successively performed, thereby securing a CD value at a correct position when measuring the CD value. Further, since the CD value may be measured at the correct position, a reliability of the obtained CD measurement value may be enhanced for use in monitoring processes, thereby increasing a success rate of a photolithography process.

Further, since the pattern recognizing rate and matching rate may be improved, a quantity of measurement points to be reviewed and re-measured may be reduced, thereby reducing a time required for global matching and enhancing an operation rate of the metrology system.

When the lengths of the X-directional edges and the Y-directional edges extracted from the GDS image are significantly different, global matching may be performed by first matching relatively shorter edges among the X-directional and Y-directional edges and then by matching relatively longer edges as discussed above with respect to blocks 212 to 224. Moreover, even if the lengths of the X-directional edge and the Y-directional edge extracted from the GDS image are not significantly different in numerical value, the global matching method discussed above with respect to blocks 212 to 224 may be performed. That is, after the GDS image and the SEM image are first matched with respect to either the X-directional edges or the Y-directional edges among the X-directional and Y-directional edges which are separately extracted from the GDS image, the GDS image and the SEM image are secondarily matched with respect to the other edges among the X-directional and the Y-directional edges which are separately extracted from the GDS image, based on a result of the first matching, thereby competing the pattern matching between the GDS image and the SEM image.

In accordance with embodiments of the present invention described above, to perform the global matching between the GDS image and the SEM image, the GDS image and the SEM image of the specific FOV region may be acquired and X-directional edges and Y-directional edges may be separately extracted from each of the GDS image and the SEM image. Then, after relatively shorter edges (among the X-directional edges and the Y-directional edges) are matched, relatively longer edges may be matched to complete the final global matching. Accordingly, a pattern matching rate may be improved, thereby reducing matching failures.

Since a pattern matching rate may be improved during the global matching, a more accurate measurement value of CD may be obtained, thereby improving reliability and/or productivity during semiconductor memory device fabrication.

Furthermore, since the pattern recognition and the pattern matching rate may be improved, a quantity of measurement points to be reviewed and/or re-measured may be reduced, thereby reducing a time required for global matching and/or increasing an operation rate of the metrology system.

While the present invention has been particularly shown and described with reference to embodiments thereof, it will be understood by those of ordinary skill in the art that various changes in form and details may be made therein without departing from the spirit and scope of the present invention as defined by the following claims.

What is claimed is:

1. A global matching method for semiconductor memory device fabrication, the method comprising:
extracting a graphic data system (GDS) image and a scanning electron microscope (SEM) image of patterns in a region on a wafer;
separately extracting first directional edges, which extend in a first direction, and second directional edges, which extend in a second direction different from the first direction and are relatively longer than the first directional edges, from each of the GDS image and the SEM image;
matching the first directional edges of the GDS image and the first directional edges of the SEM image; and
based on a result of the matching of the first directional edges, matching the second directional edges of the GDS image and the second directional edges of the SEM image, thereby completing pattern matching between the GDS image and the SEM image.

2. The global matching method according to claim 1, wherein separately extracting the first and second directional edges from the SEM image comprises:
detecting edges of the patterns in the SEM image;
squaring rounded portions of the edges to provide a straightened SEM image; and
separately extracting the first and second directional edges from the straightened SEM image.

3. A global matching method for semiconductor memory device fabrication, the method comprising:
extracting a graphic data system (GDS) image and a scanning electron microscope (SEM) image of patterns in a region on a wafer;
separately extracting first directional edges, which extend in a first direction, and second directional edges, which extend in a second direction different from the first direction, from each of the GDS image and the SEM image;
matching the first directional edges of the GDS image and the first directional edges of the SEM image; and
based on a result of the matching of the first directional edges, matching the second directional edges of the GDS image and the second directional edges of the SEM image, thereby completing pattern matching between the GDS image and the SEM image.

4. The global matching method according to claim 3, wherein separately extracting the first and second directional edges from the SEM image comprises:
detecting edges of the patterns in the SEM image;
squaring rounded portions of the edges to provide a straightened SEM image; and
separately extracting the first and second directional edges from the straightened SEM image.

5. A global matching method for semiconductor memory device fabrication, the method comprising:
extracting a graphic data system (GDS) image of patterns in a region on a wafer;
separately extracting first directional edges, which extend in a first direction, and second directional edges, which extend in a second direction different from the first direction, from the GDS image;
acquiring a scanning electron microscope (SEM) image of the pattern;
separately extracting first directional edges, which extend in the first direction, and second directional edges, which extend in the second direction and are longer than the first directional edges, from the SEM image;
matching the first directional edges of the GDS image and the first directional edges of the SEM image; and
based on a result of the matching of the first directional edges, matching the second directional edges of the GDS image and the second directional edges of the SEM image, thereby completing pattern matching between the GDS image and the SEM image.

6. The global matching method according to claim 5, wherein separately extracting the first and second directional edges from the SEM image comprises:
detecting edges of the patterns in the SEM image;
squaring rounded portions of the edges to provide a straightened SEM image; and
separately extracting the first and second directional edges from the straightened SEM image.

7. A global matching method for semiconductor memory device fabrication, the method comprising:
extracting a GDS image of patterns in a predetermined region on a wafer;
separately extracting first directional edges, which extend in a first direction, and second directional edges, which extend in a second direction different from the first direction, from the GDS image;
measuring a scanning electron microscope (SEM) image of the pattern;
separately extracting first directional edges, which extend in the first direction, and second directional edges, which extend in the second direction, from the SEM image;
matching the first directional edges of the GDS image and the first directional edges of the SEM image; and
based on a result of the matching of the first directional edges, matching the second directional edges of the GDS image and the second directional edges of the SEM image, thereby completing pattern matching between the GDS image and the SEM image.

8. The global matching method according to claim 7, wherein separately extracting the first and second directional edges from the SEM image comprises:
defining edges of the patterns in the SEM image;
squaring rounded portions of the edges to provide a straightened SEM image; and
separately extracting the first and second directional edges from the straightened SEM image.
